(19) United States
(12) Patent Application Publication
(10) Pub. No.: US 2025/0222612 A1
(43) Pub. Date: Jul. 10, 2025

(54) CUTTING APPARATUS, CUTTING DETERMINATION METHOD, AND STORAGE MEDIUM

(71) Applicant: CASIO COMPUTER CO., LTD., Tokyo (JP)

(72) Inventor: Itaru NAKAGAWA, Tokyo (JP)

(73) Assignee: CASIO COMPUTER CO., LTD., Tokyo (JP)

(21) Appl. No.: 18/986,741

(22) Filed: Dec. 19, 2024

(30) Foreign Application Priority Data
Jan. 4, 2024 (JP) 2024-000038
Oct. 17, 2024 (JP) 2024-181483

(51) Int. Cl. B26D 5/00; B26D 5/20

(52) U.S. Cl. CPC B26D 5/005; B26D 5/20

(57) ABSTRACT

A cutting apparatus includes: a sheet that includes a sheet conductive part and on which a cutting target is to be placed; a cutter blade configured to cut the cutting target; a placement table that includes a main-body conductive part electrically connectable to the sheet conductive part and on which the sheet is to be placed; a voltage sensor configured to detect a voltage across the main-body conductive part; and at least one processor. The processor causes the cutter blade to perform a cutting operation at a position corresponding to the main-body conductive part. Based on a voltage detected by the voltage sensor during the cutting operation, the processor determines whether the cutter blade is able to cut the cutting target.

### CROSS-REFERENCE TO RELATED APPLICATIONS

This application is based upon and claims the benefit of priority under 35 USC 119 of Japanese Patent Applications No. 2024-000038, filed on Jan. 4, 2024 and No. 2024-181483, filed on Oct. 17, 2024, the entire disclosure of which, including the description, claims, drawings, and abstract, is incorporated herein by reference in its entirety.

### TECHNICAL FIELD

The present disclosure relates to a cutting apparatus, a cutting determination method, and a storage medium.

### BACKGROUND ART

There is known a cutting apparatus configured to cut a cutting target. For example, Japanese unexamined patent application No. 2023-74854 describes a medium cutting device with a cutter blade. The device firstly thrusts a sheet-shaped medium as a cutting target with the cutter blade so that the cutter blade penetrates through the medium, and the device starts cutting from the thrust spot.

### SUMMARY OF THE INVENTION

According to an aspect of the present disclosure, a cutting apparatus includes: a sheet that includes a sheet conductive part and on which a cutting target is to be placed; a cutter blade configured to cut the cutting target; a placement table that includes a main-body conductive part electrically connectable to the sheet conductive part and on which the sheet is to be placed; a voltage sensor configured to detect a voltage across the main-body conductive part; and at least one processor, wherein the at least one processor causes the cutter blade to perform a cutting operation at a position corresponding to the main-body conductive part; and based on a voltage detected by the voltage sensor during the cutting operation, the at least one processor determines whether the cutter blade is able to cut the cutting target.

### BRIEF DESCRIPTION OF THE DRAWINGS

FIG. 1 is a block diagram of a cutting apparatus and a personal computer (PC) in an embodiment of the present disclosure;

FIG. 2 is a block diagram of a functional configuration of the cutting apparatus;

FIG. 3 is a perspective view of a placement table, wherein on the placement table, a sheet to which paper is attached is placed;

FIG. 4 is an exploded perspective view of the sheet and the placement table; and

FIG. 5 is a flowchart of a cutting process.

### DETAILED DESCRIPTION

Hereinafter, an embodiment of the present disclosure is described in detail with reference to the figures. The scope of the present disclosure is not limited to the illustrated examples.

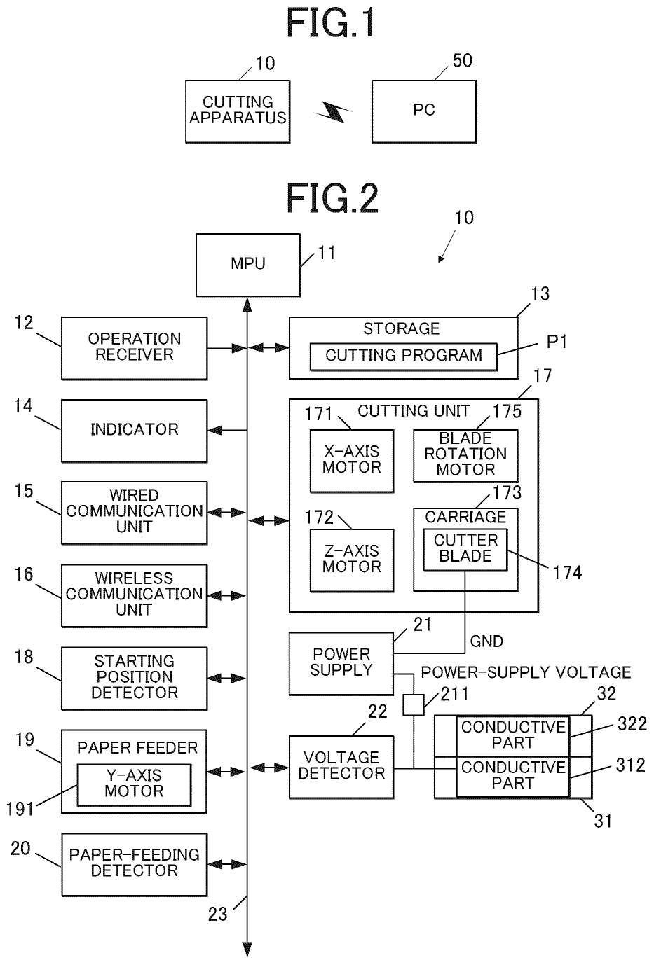

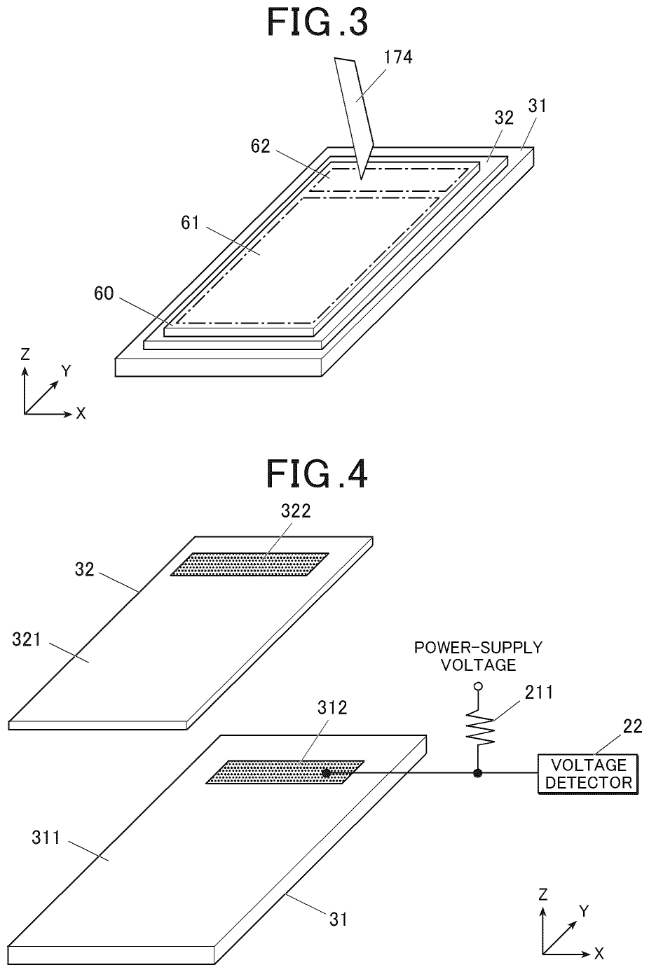

Firstly, the configuration of the embodiment is described with reference to FIG. 1 to FIG. 4. As shown in FIG. 1, a cutting apparatus 10 is configured to cut a flat medium as a cutting target, such as a rectangle medium, into a planar shape intended by a user. When the medium is thick or hard, the cutter blade may not be sufficiently stuck into the medium. As an advance check, the cutting apparatus 10 performs a test of sticking (piercing) the cutter blade into the medium and determines whether the cutter blade is sufficiently stuck into the medium. When the cutter blade is sufficiently stuck into the medium, the cutting apparatus 10 cuts the medium into the planar shape intended by the user and thereby produces a cutting product. Thus, the cutting apparatus 10 avoids completing a cutting operation without sufficiently sticking the cutter blade into the medium and thereby avoids wasting time. In this embodiment, the medium is a piece(s) of paper 60 (FIG. 3), such as a piece(s) of A-four size paper (210×297 mm), as an example. However, the medium is not limited to this example. The medium may be a resin sheet, a sticker, or a leather that can be cut by the cutter blade.

The cutting apparatus 10 is used by being wirelessly connected to a PC 50 as an information processing apparatus. The PC 50 is a desktop PC. The PC 50 includes a controller, an operation receiver, a display, and a wireless communication unit, which are not illustrated. The controller of the PC 50 performs processing in the cutting apparatus 10, such as generating and editing cutting data, based on operations input by the user through the operation receiver. The cutting data specifies the planar shape of the cutting product and the positions to be cut, as intended by the user. The PC 50 also receives inputs of operation information related to the cutting apparatus 10 and displays information related to the cutting apparatus 10, for example.

The information processing apparatus communicatively connected to the cutting apparatus 10 is not limited to the PC 50. The information processing apparatus communicatively connected to the cutting apparatus 10 may be a smartphone or a tablet PC other than the desktop PC. Bluetooth (registered trademark) is used for wireless communication between the cutting apparatus 10 and the PC 50. The wireless communication method is not limited to Bluetooth but may be other communication method, such as Wi-Fi (registered trademark). The communication connection between the cutting apparatus 10 and the PC 50 is not limited to wireless communication but may be wired communication. As wired communication, a Universal Serial Bus (USB) via a communication cable is used, for example.

Next, the internal functional configuration of the cutting apparatus 10 is described with reference to FIG. 2. The cutting apparatus 10 includes a Micro Processor Unit (MPU) 11 as a controller (processor), an operation receiver 12, a storage 13, an indicator 14, a wired communication unit 15, a wireless communication unit 16, a cutting unit 17, a starting position detector 18, a paper feeder 19, a paper-feeding detector 20, a power supply 21, a voltage detector 22, a placement table (base stand) 31, and a sheet 32. The MPU 11, the operation receiver 12, the storage 13, the indicator 14, the wired communication unit 15, the wireless communication unit 16, the cutting unit 17, the starting position detector 18, the paper feeder 19, the paper-feeding detector 20, and the voltage detector 22 are connected via a bus 23.

The cutting unit 17 includes an X-axis motor 171, a Z-axis motor 172, a carriage 173, a cutter blade 174, and a blade rotation motor 175. The paper feeder 19 includes a Y-axis motor 191. The power supply 21 includes a resistor 211. The placement table 31 includes a conductive part 312 as a main-body conductive part. The sheet 32 includes a conductive part 322 as a sheet conductive part.

The MPU 11 controls the components of the cutting apparatus 10. The MPU 11 includes a central processing unit (CPU) and a random access memory (RAM). The CPU reads a specified program among various programs stored in the storage 13, loads the program into the RAM, and executes various processes in cooperation with the loaded program. The RAM is a volatile semiconductor memory and has a work area for temporarily storing various kinds of data and programs. The operation receiver 12 includes various buttons. The operation receiver 12 receives pressing of the buttons by the user and outputs the corresponding operation information to the MPU 11. The various buttons of the operation receiver 12 include a position key for changing the position of the paper 60, a pause button for pausing the cutting operation, a setting button for setting the paper 60, and an ejection button for ejecting the paper 60, for example.

The storage 13 is, for example, a flash memory that allows reading and writing of information. The storage 13 stores various kinds of data, such as cutting data, and various programs. Specifically, the storage 13 stores a cutting program P1 for executing a cutting process, which is described later. The indicator 14 includes a light-emitting part, such as a light-emitting diode (LED), and turns on and off the light-emitting part to indicate various states of the cutting apparatus 10. For example, the indicator 14 includes a power light that indicates power on and off. The indicator 14 turns on and off the light of the light-emitting part in accordance with instructions by the MPU 11.

The wired communication unit 15 is an interface of a wired communication standard, such as the USB. Via the wired communication unit 15 and the communication cable, the MPU 11 sends and receives information to and from external apparatuses, such as the PC 50. The wireless communication unit 16 includes an antenna, a modulator-demodulator circuit, and a signal processing circuit. The wireless communication unit 16 is an interface of a wireless communication standard, Bluetooth, with external apparatuses, such as the PC 50. Via the wireless communication unit 16, the MPU 11 sends and receives information to and from external apparatuses, such as the PC 50.

The cutting unit 17 moves the cutter blade 174 mounted on the carriage 173 in the X-axis and Z-axis directions by driving the X-axis motor 171 and the Z-axis motor 172 in accordance with instructions by the MPU 11. By moving the cutter blade 174, the cutting unit 17 cuts the paper 60 attached to the sheet 32 placed (set) on the placement table 31 (pierces the paper 60 with the cutter blade 174) or cuts the paper 60 into a planar shape intended by the user. The following are descriptions of the paper 60 attached to the sheet 32 placed on the placement table 31, the X axis, the Y axis, and the Z axis with reference to FIG. 3.

The sheet 32 is used to avoid scratching the placement table 31 with the cutter blade 174 and to place the paper 60 at the correct position, for example. The paper 60 is attached to the sheet 32, and the sheet 32 with the paper 60 is placed on the placement table 31. The X axis corresponds to the moving direction of the carriage 173 with respect to the conveying direction of the placement table 31 (the sheet 32, the paper 60). The Y axis is perpendicular to the X axis and corresponds to the conveying direction of the placement table 31 (the sheet 32, the paper 60) (paper-feeding direction). The Z axis is perpendicular to the X and Y axes and corresponds to the direction in which the cutter blade 174 is moved up and down with respect to the paper 60.

The X-axis motor 171 drives the carriage 173 in the X-axis direction in accordance with instructions by the MPU 11. The Z-axis motor 172 drives the cutter blade 174 in the Z-axis direction in accordance with instructions by the MPU 11. The carriage 173 is mounted with the cutter blade 174 and movable in the X-axis direction. The cutter blade 174 is a blade made of an electric conductor, such as metal. The cutter blade 174 has, for example, a diagonal blade edge for cutting the paper 60. The blade rotation motor 175 drives and rotates the cutter blade 174 on the axial direction of the cutter blade 174.

The starting position detector 18 is, for example, an optical sensor and determines whether the cutter blade 174 is at the starting position in the X-axis direction in accordance with instructions by the MPU 11. The starting position detector 18 outputs the detection result of whether the cutter blade 174 is at the starting position to the MPU 11. Based on the detection result of whether the cutter blade 174 is at the starting position, the MPU 11 controls the position in the X-axis direction of the cutter blade 174 of the cutting unit 17.

The paper feeder 19 conveys the placement table 31 in the Y-axis direction by driving the Y-axis motor 191 in accordance with instructions by the MPU 11 in the state that the paper 60 is attached to the sheet 32 and that the sheet 32 is placed on the placement table 32. The paper-feeding detector 20 is a detector, such as an optical sensor. In accordance with instructions by the MPU 11, the paper-feeding detector 20 determines whether the placement table 31 on which the sheet 32 with the paper 60 is placed is set at the paper feed port of the paper feeder 19. The paper-feeding detector 20 outputs, to the MPU 11, the determination result of whether the paper 60 is set.

The power supply 21 adjusts the power supplied by an external power supply and supplies the adjusted power to the components of the cutting apparatus 10. An output terminal for the ground (GND) (ground potential, 0 (zero) V) of the power supply 21 is electrically connected to the cutter blade 174. As shown in FIG. 4, an output terminal that outputs a predetermined power-supply voltage of the power supply 21 is electrically connected to the input terminal of the conductive part 312 and the input terminal of the voltage detector 22 via the pull-up resistor 211. The voltage detector 22 is a voltage sensor that detects the voltage across the conductive part 312 of the placement table 31 in accordance with instructions by the MPU 11. The voltage detector 22 outputs the voltage detection result to the MPU 11. As shown in FIG. 4, the placement table 31 includes the placement table main body 311 and the conductive part 312.

As shown in FIG. 3, the surface of the paper 60 has a cutting area 61 and a determination area 62. The cutting area 61 is for generating a cutting product by cutting. The determination area 62 is an area to be cut before cutting the cutting area 61 to determine whether the paper 60 can be cut. The determination area 62 is unnecessary for producing the cutting product. As shown in FIG. 4, the placement table main body 311 is the main body of the placement table 31, and its planar shape is rectangular, for example. The placement table main body 311 is made of an insulating material. The conductive part 312 is a conductor disposed on the top surface of the placement table main body 311. The conductive part 312 is disposed at the position corresponding to the determination area 62. That is, the determination area 62 overlaps the conductive part 312 when the paper 60 is placed at the correct position with respect to the placement table 31. The conductive part 312 is disposed at a position closer to either end in the longitudinal direction of the placement table 31, for example. The area of the conductive part 312 is smaller than the area of the placement table main body 311.

The sheet 32 includes a sheet main body 321 and a conductive part 322. The sheet main body 321 is the main body of the sheet 32. The planar shape of the sheet 321 is rectangular, for example. The sheet main body 321 is shaped to fit within the planar shape of the placement table main body 311 when the sheet main body 321 is placed on the placement table 31. The sheet main body 321 is made of a soft insulating material to prevent damage to the cutter blade 174 when the cutter blade 174 cuts the paper 60. On the top surface of the sheet main body 321, an adhesive is applied to attach the pater 60.

The conductive part 322 is a conductor positioned to overlap (face) the conductive part 312. The conductive part 322 passes through the sheet main body 321 in the Z-axis direction. The conductive part 322 is electrically connected to the conductive part 312 in the state that the sheet 32 is disposed at the correct position of the placement table 31. The conductive part 322 is made of a soft conductive material, such as a conductive rubber, to avoid damage to the cutter blade 174 when the cutter blade 174 cuts the paper 60. That is, the determination area 62 overlaps the conductive part 312 with the conductive part 322 in-between when the paper 60 is placed at the correct position with respect to the placement table 31 and the sheet 32. The conductive part 322 is disposed at a position closer to either end in the longitudinal direction of the sheet 32, for example. The area of the conductive part 322 is smaller than the area of the sheet main body 321.

When the cutter blade 174 is in contact with the conductive part 322 in the state where the sheet 32 is at the correct position of the placement table 31, the voltage detector 22 detects the GND of the conductive part 312. In the same state, when the cutter blade 174 is not in contact with the conductive part 322, the voltage detector 22 detects the power-supply voltage of the conductive part 312.

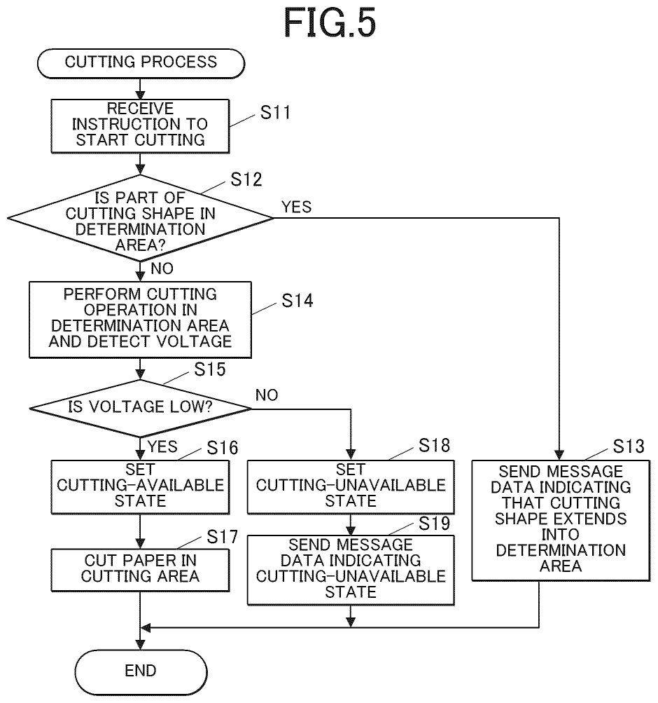

Next, the cutting process to be executed by the cutting apparatus 10 is described with reference to FIG. 5. The cutting apparatus 10 is communicatively connected to the PC 50 over wireless communication beforehand. Based on the operation input by the user specifying the planar shape (cutting shape) and positions to be cut, the PC 50 generates cutting data that specifies the positions to be cut on the paper 60 for cutting the paper 60 into the planar shape intended by the user. The PC 50 then sends the cutting data to the cutting apparatus 10. The MPU 11 of the cutting apparatus 10 receives the cutting data, which includes the planar shape and the positions to be cut, from the PC 50 via the wireless communication unit 16 and stores the received cutting data in the storage 13.

The user attaches the paper 60 as the cutting target to a predetermined position of the sheet 32. When the paper 60 is at the correct position of the sheet 32, the determination area 62 overlaps (faces) the conductive part 322. The user then places the sheet 32, to which the paper 60 is attached, at a predetermined position of the placement table 31. When the sheet 32 is at the correct position of the placement table 31, the determination area 62 overlaps (faces) the conductive part 312.

The user then sets the placement table 31, which is mounted with the sheet 32 to which the paper 60 is attached, to the paper feed port of the paper feeder 19. The user inputs a cutting start instruction via the operation receiver of the PC 50. The PC 50 sends the input cutting start instruction to the cutting apparatus 10. In response to receiving the information to perform cutting from the PC 50 via the wireless communication unit 16, the MPU 11 of the cutting apparatus 10 executes the cutting process in accordance with the cutting program P1 stored in the storage 13.

The MPU 11 firstly completes receiving the input cutting start instruction from the PC 50 (Step S11). The MPU 11 determines whether at least part of the cutting shape, which is specified in the cutting data, extends out of the cutting area 61 into the determination area 62 (Step S12). The cutting in the determination area 62 for the advance check is performed regardless of the cutting shape intended by the user in Step S14, as described later. Therefore, the MPU 11 determines whether the cutting for the advance check may damage the paper 60 and result in a cutting product having a shape different from the shape intended by the user. If the cutting for the advance check damages the cutting product, it is highly possible that the cutting product has a shape different from the shape intended by the user and that the paper 60 is wasted as a result.

When determining that at least part of the cutting shape, which is specified in the cutting data, extends into the determination area 62 (Step S12: YES), the MPU 11 generates message data indicating that at least part of the cutting shape extends into the determination area 62 and sends the message data to the PC 50 (Step S13). The message data, which indicates that at least part of the cutting shape is in the determination area 62, means that the cutter blade 174 may cut the paper 60 into a shape different from the shape intended by the user and that the paper 60 may be wasted as a result. Then the cutting process ends. In response to Step S13, the controller of the PC 50 receives the message data and displays the message on the display.

When determining that the cutting shape, which is specified in the cutting data, does not extend into the determination area 62 (Step S12: NO), the MPU 11 drives the cutting unit 17, the paper feeder 19, and so forth to convey the paper 60 and to move the cutter blade 174 to a position corresponding to the determination area 62 (i.e., the position corresponding to the conductive part 312) and performs the cutting operation. That is, the MPU 11 performs the cutting for the advance check (Step S14). In Step S14, the MPU 11 causes the voltage detector 22 to detect the voltage of the conductive part 312.

The MPU 11 determines whether the voltage detected in Step S14 is low (GRD) (Step S15). When the voltage is low (Step S15: YES), the low voltage indicates that the cutter blade 174 pierces through the determination area 62 of the paper 60, thereby properly cutting the paper 60. Therefore, the MPU 11 sets the state as the cutting-available state (step S16).

The MPU 11 drives the cutting unit 17, the paper feeder 19, and so forth to convey the paper 60 and move the cutter blade 174 to the position corresponding to the cutting area 61. The MPU 11 then performs the cutting operation on the paper 60, based on the cutting data in the storage 13 (step S17). In Step S17, the cutting product is produced. The cutting process then ends.

When the voltage detected in Step S14 is high (power-supply voltage) (Step S15: NO), the cutter blade 174 does not properly cut the determination area 62 of the paper 60. Therefore, the MPU 11 sets the state as the cutting-unavailable state (step S18). The MPU 11 generates message data indicating that the cutting cannot be performed and sends the generated message data to the PC 50 via the wireless communication unit 16 (Step S19). The cutting process then ends. In response to Step S13, the controller of the PC 50 receives the message data and displays the message on the display.

As described above, according to the embodiment, the cutting apparatus 10 includes the sheet 32, the cutter blade 172, the placement table 31, the voltage detector 22, and the MPU 11. The sheet 32 includes the conductive part 322. On the sheet 32, the paper 60 is to be placed. The cutter blade 174 is configured to cut the paper 60. The placement table 31 includes the conductive part 312 that is disposed at a position corresponding to the conductive part 322 to be electrically connectable to the conductive part 322. On the placement table 31, the sheet 32 is to be placed. The voltage detector 22 detects a voltage across conductive part 312. The MPU 11 causes the cutter blade 174 to perform the cutting operation at a position (the determination area 62) corresponding to the conductive part 312. Based on a voltage detected by the voltage detector 22 during the cutting operation, the MPU 11 determines whether the cutter blade 174 can cut the paper 60.

According to the above configuration, the cutting apparatus 10 can determine whether the cutting can be performed in the state where the cutter blade 174 sufficiently pierces through the paper 60. Accordingly, the cutting apparatus 10 can avoid wasting time by completing the cutting operation based on the cutting data without sufficiently piercing the paper 60 with the cutter blade 174. Further, the cutting apparatus 10 can avoid wasting the paper 60 by cutting the paper 60 without sufficiently piercing the paper 60 with the cutter blade 174.

Further, the cutter blade 174 is grounded; the conductive part 312 receives the power-supply voltage; in a situation that the voltage detected during the cutting operation is the GND, the MPU 11 determines that the cutter blade 174 can cut the paper 60; and in a situation that the detected voltage is the power-supply voltage, the MPU 11 determines that the cutter blade 174 cannot cut the paper 60. According to such a configuration, the user can easily and accurately determine whether the cutter blade 174 can cut the paper 60. As a different configuration, the cutter blade 174 may receive the power-supply voltage, and the conductive part 312 may be grounded. For example, one terminal of the resistor 211 in FIG. 4 may be electrically connected to the voltage detector 22 and the conductive part 312, and the other terminal of the resistor 211 may be electrically connected to the GND output terminal of the power supply 21. In such a configuration, the cutter blade 174 is electrically connected to the output terminal that outputs the power-supply voltage of the power supply 21. However, in the configuration, the cutter blade 174 receiving the power-supply voltage is exposed. When the cutter blade 174 is in contact with an external object (e.g., a finger of the user), current may flow into the object. It is therefore preferable that the cutter blade 174 be grounded and the conductive part 312 receive the power-supply voltage.

In a situation that at least part of the cutting shape, which is specified in the cutting data, is in the determination area 62 of the paper 60, the determination area 62 corresponding to the conductive part 322, the MPU 11 displays the message on the PC 50 to notify the user that the cutter blade 174 may cut the paper 60 into a shape different from the shape intended by the user and that the paper 60 may be wasted as a result. The MPU 11 then ends the cutting process. By performing the cutting operation in the determination area 62, the cutting apparatus 10 can avoid wasting the paper 60 and guide the user to take appropriate measures. The measures are, for example, changing the cutting data.

Further, in response to determining that the cutter blade 174 cannot cut the paper 60, the MPU 11 notifies the user that the cutter blade 174 cannot cut the paper 60 by displaying the message on the PC 50. Thus, the cutting apparatus 10 allows the user to recognize that the cutter blade 174 cannot cut the paper 60 and guides the user to take appropriate measures so that the cutter blade 174 can cut the paper 60. The measures are, for example, changing the paper 60 to a cutting target having a thickness through which the cutter blade 174 can pierce, changing the cutter blade 174, and adjusting the sheet 32 and the paper 60 with respect to the placement table 31.

In the above description, the storage 13, such as a flash memory, is used as an example of a computer-readable medium that stores the program according to the present disclosure. However, the present disclosure is not limited to this example. As other examples of computer-readable storage media, a read-only memory (ROM) or a portable storage medium, such as a CD-ROM, can also be used. Further, a carrier wave may be used as a medium to provide data of the programs of the present disclosure via a communication line.

The embodiment described above is an example of the cutting apparatus, the cutting determination method, and the storage medium according to the present disclosure, and the present invention is not limited to the example.

For example, in the above embodiment, the MPU 11 of the cutting apparatus 10 generates the message data and sends the data to the PC 50 so that the PC 50 displays the message. However, the present invention is not limited to this configuration. For example, the cutting apparatus 10 may include a display configured to display the message, such as a liquid crystal display (LCD). In such a configuration, the MPU 11 generates the message data and displays the message on the display of the cutting apparatus 10.

Further, the configuration may be modified such that the user is not allowed to set the cutting data in the determination area. For example, the controller of the PC 50 executes a cutting data generation process for generating the cutting data, based on the operation input on the operation receiver by the user; in the cutting data generation process, the controller determines whether at least part of the cutting shape, which is specified in the cutting data based on the input operation, is in the determination area; when at least part of the cutting shape is in the determination area, the controller displays a warning message on the display. The warning message warns that at least part of the cutting shape is in the determination area, that the cutting product may have a shape different from the shape intended by the user, and that the paper may be wasted, for example. Herein, the controller receives operation input by the user via the operation receiver to generate modified cutting data, for example. For another example, when at least part of the cutting shape, which is specified in the cutting data based on the input operation, is in the determination area, the controller may end the process without setting the cutting data. That is, the configuration prohibits generation of cutting data that specifies a cutting shape at least part of which extends into the determination area.

Although an embodiment of the present disclosure has been described, the scope of the present disclosure is not limited to the embodiment described above but encompasses the scope of the disclosure recited in the claims and the equivalent thereof.

What is claimed is:

1. A cutting apparatus comprising:
a sheet that includes a sheet conductive part and on which a cutting target is to be placed;
a cutter blade configured to cut the cutting target;
a placement table that includes a main-body conductive part electrically connectable to the sheet conductive part and on which the sheet is to be placed;
a voltage sensor configured to detect a voltage across the main-body conductive part; and
at least one processor, wherein
the at least one processor causes the cutter blade to perform a cutting operation at a position corresponding to the main-body conductive part; and
based on a voltage detected by the voltage sensor during the cutting operation, the at least one processor determines whether the cutter blade is able to cut the cutting target.

2. The cutting apparatus according to claim 1, wherein
the cutter blade is grounded;
the main-body conductive part receives a power-supply voltage;
in a situation that the voltage detected by the voltage sensor during the cutting operation is a ground potential, the at least one processor determines that the cutter blade is able to cut the cutting target; and
in a situation that the voltage detected by the voltage sensor during the cutting operation is the power-supply voltage, the at least one processor determines that the cutter blade is not able to cut the cutting target.

3. The cutting apparatus according to claim 1, wherein in a situation that at least part of a cutting shape input and set by a user overlaps the main-body conductive part, the at least one processor notifies that there is a possibility that the cutting target is cut into a shape different from a shape intended by the user.

4. The cutting apparatus according to claim 1, wherein in response to determining that the cutter blade is not able to cut the cutting target, the at least one processor notifies that the cutter blade is not able to cut the cutting target.

5. The cutting apparatus according to claim 4, wherein in response to determining that the cutter blade is able to cut the cutting target, the at least one processor causes the cutter blade to cut the cutting target into a cutting shape set by the user.

6. The cutting apparatus according to claim 1, wherein the sheet conductive part is disposed at a position closer to either end of the sheet in a longitudinal direction of the sheet.

7. The cutting apparatus according to claim 6, wherein
the sheet includes a sheet main body made of an insulating material; and
an area of the sheet conductive part is smaller than an area of the sheet main body.

8. The cutting apparatus according to claim 6, wherein the main-body conductive part is disposed at a position closer to either end of the placement table in a longitudinal direction of the placement table.

9. The cutting apparatus according to claim 8, wherein
the placement table includes a placement-table main body made of an insulating material; and
an area of the main-body conductive part is smaller than an area of the placement-table main body.

10. A cutting determination method to be executed by a cutting apparatus that includes:
a sheet that includes a sheet conductive part and on which a cutting target is to be placed;
a cutter blade configured to cut the cutting target;
a placement table that includes a main-body conductive part electrically connectable to the sheet conductive part and on which the sheet is to be placed; and
a voltage sensor configured to detect a voltage across the main-body conductive part,
the cutting determination method comprising:
causing the cutter blade to perform a cutting operation at a position corresponding to the main-body conductive part; and
determining whether the cutter blade is able to cut the cutting target, based on a voltage detected by the voltage sensor during the cutting operation.

11. The cutting determination method according to claim 10, wherein
the cutter blade is grounded; and
the main-body conductive part receives a power-supply voltage,
wherein in the determining, in a situation that the voltage detected by the voltage sensor during the cutting operation is a ground potential, it is determined that the cutter blade is able to cut the cutting target; and in a situation that the voltage detected by the voltage sensor during the cutting operation is the power-supply voltage, it is determined that the cutter blade is not able to cut the cutting target.

12. The cutting determination process according to claim 10, wherein in the determining, in a situation that at least part of a cutting shape input and set by a user overlaps the main-body conductive part, it is notified that there is a possibility that the cutting target is cut into a shape different from a shape intended by the user.

13. The cutting determination method according to claim 10, wherein in the determining, in response to determining that the cutter blade is not able to cut the cutting target, it is notified that the cutter blade is not able to cut the cutting target.

14. The cutting determination method according to claim 13, wherein in the determining, in response to determining that the cutter blade is able to cut the cutting target, the cutter blade is caused to cut the cutting target into a shape set by the user.

15. The cutting determination method according to claim 10, wherein the sheet conductive part is disposed at a position closer to either end of the sheet in a longitudinal direction of the sheet.

16. The cutting determination method according to claim 15, wherein
the sheet includes a sheet main body made of an insulating material; and
an area of the sheet conductive part is smaller than an area of the sheet main body.

17. The cutting determination method according to claim 15, wherein the main-body conductive part is disposed at a position closer to either end of the placement table in a longitudinal direction of the placement table.

18. The cutting determination method according to claim 17, wherein
the placement table includes a placement-table main body made of an insulating material; and
an area of the main-body conductive part is smaller than an area of the placement-table main body.

19. A non-transitory storage medium storing a program readable by a computer of a cutting apparatus that includes:
a sheet that includes a sheet conductive part and on which a cutting target is to be placed;
a cutter blade configured to cut the cutting target;
a placement table that includes a main-body conductive part electrically connectable to the sheet conductive part and on which the sheet is to be placed; and
a voltage sensor configured to detect a voltage across the main-body conductive part,
wherein the program causes the computer to
cause the cutter blade to perform a cutting operation at a position corresponding to the main-body conductive part and
determine whether the cutter blade is able to cut the cutting target, based on a voltage detected by the voltage sensor during the cutting operation.

20. The storage medium according to claim 19, wherein
the cutter blade is grounded;
the main-body conductive part receives a power-supply voltage;
in a situation that the voltage detected by the voltage sensor during the cutting operation is a ground potential, the computer determines that the cutter blade is able to cut the cutting target; and
in a situation that the voltage detected by the voltage sensor during the cutting operation is the power-supply voltage, the computer determines that the cutter blade is not able to cut the cutting target.
